(19) United States
(12) Patent Application Publication
(10) Pub. No.: US 2010/0098823 A1
(43) Pub. Date: Apr. 22, 2010

(54) Portable electrical piston-driven espresso machine

(76) Inventors: Chris Nenov, Palm Harbor, FL (US); Peter Petrov, Palm Harbor, FL (US)

Correspondence Address: Chris Nenov, 1876 Painted Bunting Cir, Palm Harbor, FL, 34683, US

(21) Appl. No.: 12/288,391

(22) Filed: Oct. 20, 2008

(51) Int. Cl. A47J 31/36

(52) U.S. Cl. 426/433; 99/302 P

(57) ABSTRACT

A method of making espresso and a portable espresso machine incorporating that method that is compact, lightweight, requires low power, and is readily transportable. The quantity of water required to make espresso is heated to the brewing temperature in a boiler equipped with a piston. The piston is driven by an electric motor. During the brewing cycle, the hot water is pushed by the piston through the compacted coffee contained in the portafilter. The rate of piston movement is chosen such that the coffee in the portafilter is infused by the hot water at the high pressure necessary for making espresso, typically about 100 psi or higher, and also such that the contact between the coffee and water is of a duration suitable for making espresso, typically about 15-25 seconds. The components are thermally insulated and strategically placed to minimize the size of the machine and allow for portability.

### BACKGROUND OF THE INVENTION

A defining characteristic of conventional electrical espresso machines is that the coffee grinds are infused with hot water under a substantially constant high pressure supplied by an electrical water pump. The hot water pressure is usually more than 100 psi throughout the infusion/extraction cycle.

Conventional electrical espresso machines contain the following major components in sequence: a cold water reservoir or direct connection to an external cold water supply; a cold water pump; a boiler or thermo-block; a group or brew head; and a portafilter. These components are usually arranged in a side-by-side relation. The machines operate as follows: In the arrangement incorporating a boiler, the boiler is filled with water and preheated to a temperature greater than about 180 deg F., prior to activating the high-pressure water pump. During the brewing process, the pump takes cold water from the water reservoir and injects it into the boiler under a pressure greater than 100 psi. The pressure of the incoming water forces the hot water already in the boiler into the group or brew head. In the arrangement incorporating a thermoblock, the latter is preheated prior to activating the high-pressure water pump which forces cold water into it. The pressurized cold water is heated while traversing the powered thermoblock and enters the brew head at a temperature compatible with the making of espresso. In either arrangement, after entering the brew head the hot water infuses the coffee in the portafilter and exits into a cup or other receptacle placed under the portafilter.

In either of the above arrangements, the water pressure during the brewing cycle is created by the inflow of pressurized cold water from the pump into the preheated boiler or thermoblock. In the case of the boiler arrangement, in order to avoid substantial cooling of the preheated water as a result of the addition of pressurized cold water the size of the boiler is usually large, typically about 400 ml or more. In turn, the large boiler size requires a large heater, typically 1 kW or more. Similarly, in the case of the thermoblock arrangement, the water has to be heated rapidly (in about 15-25 seconds) from room temperature to the brewing temperature. Such rapid heating requires a large thermoblock surface area and a heater of about 1 kW or more. In either case, the large sizes of the heater and boiler or thermoblock necessitate significant thermal insulation and spacing of the components, add weight, and preclude portability.

As a result, conventional espresso machines for home use are usually larger than about 14 inches high, 10 inches long, and 8 inches deep, and weigh more than twenty pounds. While in-home espresso machines are commonplace, they are difficult to transport due to their large size, weight, and inconvenient form factor. They cannot be easily packed for a trip, carried onto a plane, or used in a car or on a boat. To be portable, an espresso machine should be lightweight, compact, devoid or protruding parts, should not occupy a large volume, and ideally should be able to be carried onto a plane. It should be sufficiently sturdy to withstand rough handling. Furthermore, to be usable in a passenger vehicle such as a car or a boat, a portable espresso machine should also be spill-proof and also require no more power than available through a typical vehicle's power outlet, typically 120 W dc. No conventional portable electrical espresso machines exist. As a result, travelers are inconvenienced, and in many instances unable to enjoy espresso.

A first portable electrical espresso machine is described in US Patent Application No. 2006/0107839 A1. By introducing two-stage heating, that machine reduces the size and power requirements resulting in enhanced portability over conventional espresso machines. However, the portable espresso machine described by the above patent application is still driven by a high-pressure water pump and still requires a water reservoir separate from the thermoblock, preventing further size reduction. Moreover, its two heaters add complexity and weight and present limits to portability.

### SUMMARY OF THE INVENTION

The problems of the prior art have been overcome by the present invention, which provides an improved portable espresso machine that is compact, lightweight, requires minimal power to operate, and is readily transportable. Also provided is a method of dispensing espresso.

The machine of the present invention adopts a radically different approach to portability which involves eliminating the high-pressure water pump and separate water reservoir or continuous water source characteristic of conventional electrical espresso machines but also of the portable machine of US Patent Application No. 2006/0107839 A1. In the machine of the present invention, the water pump is replaced by a motor-driven piston acting within the boiler. In addition to eliminating the need for a separate water reservoir or continuous water source, the piston arrangement reduces the boiler size and heater power requirements. As a result, the instant arrangement permits low power requirements similar to that of the prior art machine of US Patent Application No. 2006/0107839 A1 but allows for further substantial size reduction due to the removal of the high-pressure pump, water reservoir, and first-stage heater required by that prior art machine.

The instant machine's components are thermally insulated and strategically placed to allow for portability. Preferably, the major dimension of the apparatus does not exceed twelve inches, and preferably the entire apparatus weighs about five pounds or less. The required continuous power for operation of the electrical components of the machine preferably does not exceed about 120 W. In certain embodiments, the machine can be disassembled into two or more pieces for convenient storage and transport. In certain embodiments, an optional permanent or removable cold water reservoir may be added allowing automatic refilling of the boiler during the downward travel of the piston during the brewing cycle.

### BRIEF DESCRIPTION OF THE DRAWINGS

FIG. 1 is a cross-sectional view of a portable espresso machine in accordance with the present invention.

FIG. 2, a composite of seven figures, shows the principal operation sequence of the instant machine.

FIG. 3 is a cross-sectional view of another possible embodiment of the present invention, incorporating a non-stationary drive screw and an optional cold water reservoir for automatic refilling of the boiler.

### DETAILED DESCRIPTION OF THE INVENTION

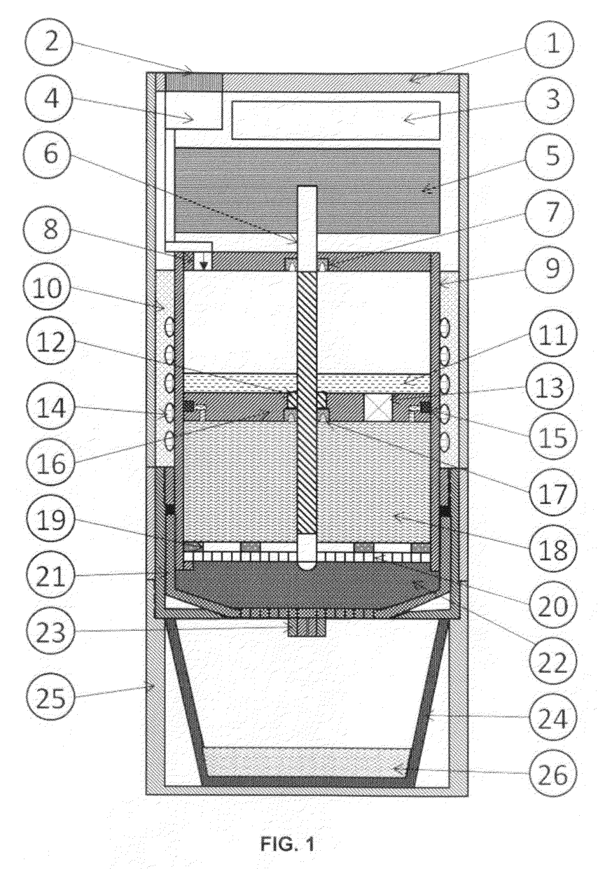

Turning first to FIG. 1, a vertically stacked portable electrical espresso machine in accordance with the present invention is shown in a cross-sectional view. The machine shown here has a cylindrical or elliptical cross-section although other cross-sections are also feasible without changing the basic concept of the invention.

The machine in FIG. 1 includes a top cover 1 with a fill cap 2 secured to the top cover by any suitable means, such as by screwing, latching, or with a snap-on fit. The cap 2 closes the fill port 4 into which water is poured to fill the boiler prior to brewing. Optionally, to prevent spillage of water during filling, a filling bottle or another device may be used by the operator. Located below the top cover 1 are the electronics compartment 3 and the electric motor 5. The motor may be of continuous or step type, ac or dc. To allow portability in terms of available electric power and size, the power consumption of the electric motor is preferably not more than about 100 W. In the embodiment shown in FIG. 1, the motor 5 imparts a two-way rotational motion to the drive screw 6 which spins but does not translate up or down. Depending on the type of motor used, the screw driving mechanism may include gears to achieve the required screw rpm and a clutch to allow slippage when a certain torque limit is exceeded. The motor may also include an electrical current overload safety device.

Located below the electric motor 5 is the boiler 9. The drive screw 6 which incorporates threaded and smooth sections enters the boiler through the seal 7. The seal prevents water from exiting the boiler. Although FIG. 1 shows a simple urethane, PTFE, or Teflon seal, it will be obvious to those skilled in the art that various seal configurations and materials are possible. Water enters the boiler through the check valve 8 which also serves to prevent water egress from the boiler. Preferably, the volume of the boiler is between about 40 to 80 ml but may be smaller or larger as required. A heater 14 is wrapped around the boiler 9, and the assembly is thermally insulated 10. The type of heater is not particularly limited and various arrangements are possible. For instance, as an alternative to the wrap-around arrangement shown, the heater may be contained within the boiler's wall, or sandwiched between the boiler's double-walls. Preferably, to allow portability yet minimize the time required for heating the power of the heater will be about 100 W, but higher or lower power heaters may also be used. In certain embodiments, a dual-power heater may be used, with a high-power stage utilized when an adequate electricity source is available such as from a wall outlet. Another possible arrangement may involve two separate heaters, spaced vertically to allow selective heating of only the bottom part of the boiler when a smaller quantity of heated water is desired (such as required for a single vs. a double shot of espresso).

The boiler is separated into two compartments by the piston 16. The piston 16 can be made of a variety of lightweight materials or combination thereof. Preferably, to minimize the time required for heating the water in the boiler, the piston 16 will not readily store and conduct heat. The piston 16 incorporates a nut 12 which rides on the threaded portion of the drive screw 6. Because the piston 16 and nut 12 are joined and jointly prevented from rotation, when the motor 5 turns the drive screw 6 the nut 12 rides the threads of that screw and moves up and down within the boiler together with the piston 16. Although the inclusion of the nut 12 is desirable because of the different mechanical requirements that may apply to the piston and nut materials, in certain embodiments the nut 12 may be omitted and the piston 16 may be threaded to ride directly on the screw 6.

The direction of movement of the piston 16 (up or down) depends on the direction of rotation of the screw 6. In order to achieve transformation of the screw's rotation into translation of the piston, the piston and nut assembly is prevented from rotation by means of a device such as a key notch, or by making the cross-sections of the boiler cavity and the piston slightly elliptical, or by another suitable method.

The piston 16 incorporates a check valve 13 which allows water to pass from the boiler compartment above the piston to the one below during the upward stroke of the piston but prevents passage of water in the opposite direction during the piston's downward stroke. During the brewing cycle, as the piston 16 is moved downward a pressure of about 100 psi or higher builds up in the part of the boiler below the piston while the boiler compartment above the piston remains at near atmospheric pressure (the pressure above the piston 16 is equalized through-the valve 8 and the fill port 4 preventing vacuum from forming above the piston). In addition to the check valve 13, the piston ring seal 15 and the screw seal 17 jointly prevent pressurized water 18 from escaping into the compartment above the piston. Like the boiler seal 7, the piston ring seal 15 and the screw seal 17 can have various configurations and be made of a variety of materials. In the embodiment shown in FIG. 1, the inner diameter of the PTFE or Teflon piston ring seal 15 is in communication with the water in the boiler compartment below the piston. Such an arrangement allows the sealing pressure and sealing effectiveness to increase as the pressure below the piston builds up. Similarly, the screw seal 17 shown in FIG. 1 is compliant and conforming to the threads of the drive screw, and also activated by the water pressure below the piston. Urethane or other materials known to those skilled in the art can provide adequate sealing. It will be obvious from FIG. 1 that perfect sealing between the sub- (18) and supra-piston (11) boiler compartments may not be necessary and that inter-compartmental leakage of pressurized water at a rate less than about 5 ml per minute may be acceptable.

At the bottom of the boiler compartment 9 are the showerhead 20 and the optional spacer 19. Jointly, they distribute the pressurized hot water over the compacted coffee 22 and prevent the ingress of coffee grinds into the boiler. Preferably, the spacer 19 and showerhead 20 are easily removable for periodic cleaning. Not shown in FIG. 1 are a thermocouple or thermostat which sense the water temperature in the boiler and signal readiness when the brewing temperature has been reached (typically between 185 and 210 deg F.). The simplest implementation of temperature control involves a device such as bimetallic snap-disk thermostat, however a thermocouple may be preferred for greater precision. The use of a thermocouple in an electronic feedback loop may allow the operator to select and control the precise brewing temperature. For further operator control, an optional pressure sensor may be installed in the lower section of the boiler and used to provide pressure readings and electronic feedback. For operator protection, the boiler may include an optional overtemperature thermostat and overpressure valve.

A portafilter basket 21 sits in the portafilter and holds ground coffee in the form of tampered grinds as shown in FIG. 1, or in the form of coffee pods or capsules. The portafilter basket 21 can be pressurized (as shown in FIG. 1) or non-pressurized. The basket 21 may include a crema nozzle 23. The nozzle 23 can be permanent on changeable for use with the pressurized basket. Different nozzles may be used with different coffee types, containers, and grind sizes in order to produce optimum results, which generally requires an infusion time (the time during which the pressurized hot water and the coffee grinds are in contact with one another) of about 15-25 seconds at an optimal pressure (usually about 130 psi, depending on the characteristics of the coffee that is used). In conventional machines, but also in the portable machine of US Patent Application No. 2006/0107839 A1 both the infusion time and infusion pressure are variable and interdependent. The variability and interdependence are a function of many parameters, and limit the reproducibility of the espresso quality. In contrast, for the instant machine the infusion time is determined by the rate of rotation of the screw 6 and the screw and nut (12) thread characteristics. If a stepper motor is used, the infusion rate may be independently selectable leaving the water pressure at the showerhead as the only variable to be controlled by the combination of coffee grind and portrafilter basket parameters, including the crema nozzle. If even greater operator control is desired, provided that the motor has sufficient torque the rate of screw rotation may be varied by electronically or electrically by varying the rpm of the electric motor 5. Thus, the instant machine can achieve greater reproducibility and operator flexibility than conventional espresso machines.

A cup holder 25 containing a cup 24 is attached to the portafilter to receive the freshly brewed espresso 26. The cup holder and cup may be vented in order to prevent pressure build-up and may be attached to the portafilter in such a way as to allow operation without spillage in a car or boat, or with the machine standing up on the cup holder 25. Although preferable for use in a car or boat, the cup holder and cup are not essential to the operation of the machine as the machine can be held over any suitable cup during the brewing cycle without the cup holder 25 and the cup 24 installed.

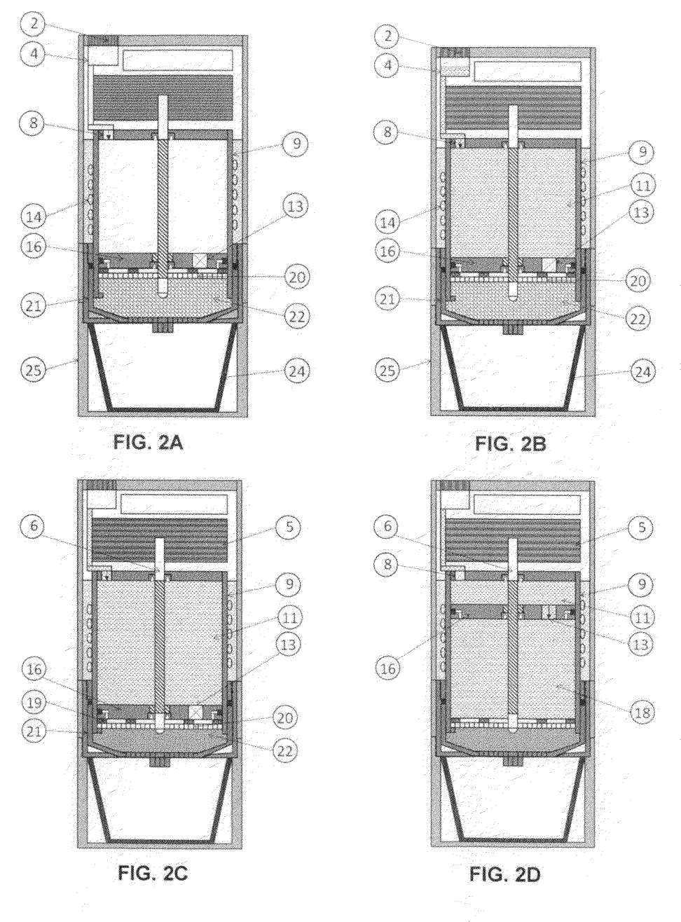

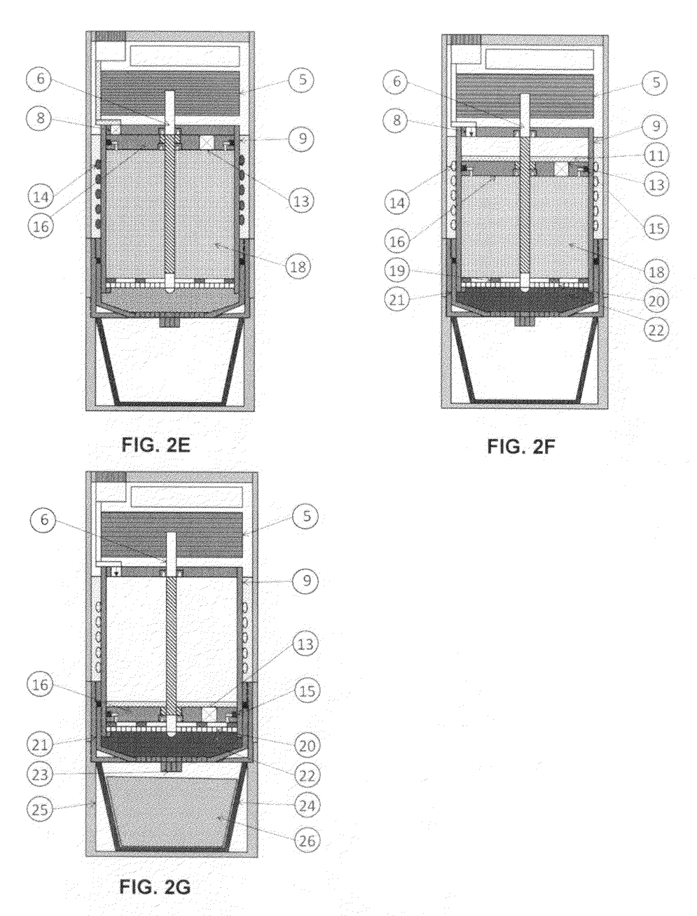

FIG. 2 shows the principal operation sequence of the instant machine. Starting with FIG. 2A, the piston 16 is in the loading position. Fresh ground coffee 22 has been placed in the portafilter basket 21. Although loose ground coffee is shown in FIG. 2A, prepackaged espresso pods and capsules can be used as well. In FIG. 2B, water has been filled into the boiler compartment 9 above the piston 16 through the fill cap 2, fill port 4, and check valve 8.

Subsequently, the electric motor 5 rotates the piston screw 6 moving the piston 16 downward. The piston pushes against the spacer 19 and showerhead 20. In turn, those compact the ground coffee 22 (FIG. 2C). For denser packing of the ground coffee, several on/off or forward/reverse cycles can be used under electronic control to achieve a compressive action similar to manual stomping. The number of stomping cycles can be programmable by the operator. The stomping step may not be necessary when prepackaged espresso pods or capsules are used.

The motor 5 then rotates the drive screw 6 in the opposite direction moving the piston 16 upward (FIG. 2D). As the piston moves upward, check valve 13 allows water 11 to flow from the boiler compartment 11 above the piston 16 into the boiler compartment 18 below the piston. Preferably, during the upward stroke the rate of flow through the valve 13 is such that the water pressure above the piston remains near atmospheric. Depending on their characteristics, more than one valves 13 may be required to achieve such a flow rate. At the same time, during the upward stroke of the piston 16 the valve 8 prevents water 11 from the boiler compartment above the piston from exiting the boiler and migrating into the fill port.

The upward piston stroke continues until the piston 16 has reached the top of the boiler compartment 9 (FIG. 2E). At that time, all or almost all of the water in the boiler compartment 9 has migrated to the space 18 under the piston 16.

The heater 14 is usually activated after the piston 16 has reached the end of the upward stroke (FIG. 2E). Heating continues until the desired brew temperature is reached, as sensed by the thermostat or thermocouple (not shown in FIG. 2E). Depending on the power of the heater, the volume of the boiler, and the starting temperature of the water, heating can take from about 3 to 6 minutes. In some cases, when power is not at a premium and concurrent operation of the electric motor 5 and the heater 14 is possible, the heater 14 may be activated earlier, for instance immediately after the boiler has been filled with water (FIG. 2B). Earlier heater activation will result in a reduced cycle time. Alternatively, as described earlier the heater 14 may be split into two or more heating zones, with one or more of the zones operating concurrently with the electric motor 5 without exceeding the power limit of the electricity source.

Once the brewing temperature has been reached, the heater 14 is turned off and the motor 5 is activated to rotate the screw 6 in the opposite direction and begin the downward stroke of the piston 16 (FIG. 2F, brewing stroke). As the piston 16 starts moving downward, the check valve 13, the ring seal 15, and the screw seal 17 jointly prevent hot water 18 below the piston 16 from escaping into the compartment 11 above the piston. Simultaneously, at the bottom of the boiler the compacted coffee 22 and the portafilter basket 21 jointly obstruct the flow of hot water out of the boiler until a considerable pressure has built up. This results in infusion of the ground coffee with hot water under considerable pressure appropriate for brewing espresso (usually between about 100 and 250 psi).

Optionally, the instant machine may be programmed so that the downward stroke of the piston 16 is interrupted for a few second (typically about 3 to 5 seconds) after an initial short distance has been traversed and the coffee 22 has been infused with a small amount of water (about 3 to 10 ml) (FIG. 2F). This process is called pre-infusion and is thought to result in enhanced properties of the espresso. In certain embodiments of the instant machine, the operator may be able to program the duration of the pre-infusion stroke, and also the time delay before the downward stroke resumes.

After pre-infusion, the motor 5 is activated again, the piston screw 6 turns, and the downward stroke of the piston 16 proceeds until all of the remaining hot water 18 has been expressed through the compacted infused ground coffee 22 and into the cup 24 as espresso 26 (FIG. 2G). Alternatively, the operator may interrupt the brewing cycle at an earlier stage, resulting in a stronger or smaller-size beverage.

After completion of the brewing cycle, the motor 5 may be reversed automatically to lift the piston 16 to the position of FIG. 2A. The lifting of the piston 16 at the end of the brewing cycle relieves the pressure under the piston, preventing splatter upon removal of the portafilter for disposal of the spent coffee. After disposal of the spent coffee, the machine is ready for reloading with fresh coffee and refilling with water.

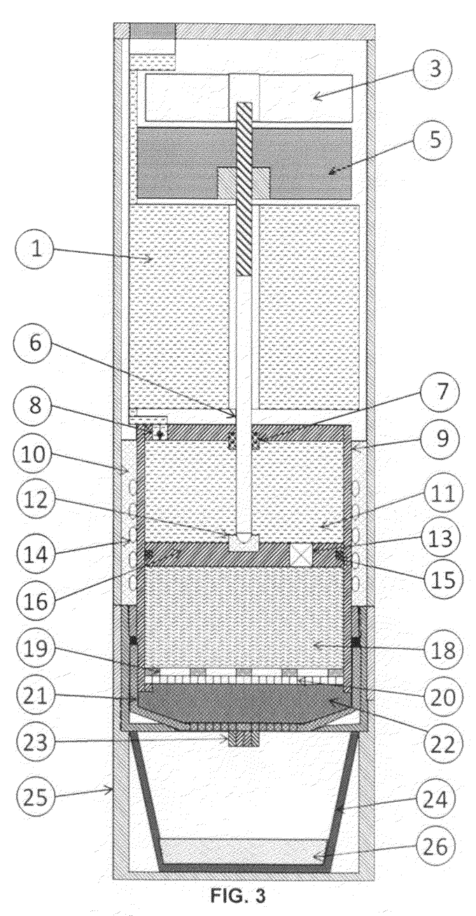

Some embodiments of the present invention may incorporate an optional water reservoir 1 shown in FIG. 3. In that case, during the brewing cycle as the piston 16 travels downward water from the reservoir 1 flows through the valve 8 into the boiler compartment 11 above the piston. Thus, at the end of the brewing cycle the machine is already filled with water and ready for the next cycle. The embodiment shown in FIG. 3 is less compact but requires less frequent refilling with water.

It will be obvious to those skilled in the art that in addition to the arrangement shown in FIG. 1 there are various piston, gear, and drive screw arrangements, such as the example shown also in FIG. 3, where the drive screw is not stationary but is moved up and down by gears in the electrical motor. In another possible embodiment of the present invention, the electric motor may not be mounted in-line with the boiler but instead may be contained in a handle extending sideways from the main body of the device, with only the gear drive positioned above the boiler. In a further embodiment not shown here the electric motor 5, instead of acting directly on the piston 16 within the boiler 9, can actuate a separate hydraulic piston that can amplify the force exerted upon the brewing piston and reduce the power, torque, and size required of that motor.

The geometric relations and arrangements of the various components in FIG. 1 and FIG. 3 represent two of the possible embodiments of the present invention. Those skilled in the art would appreciate that many such embodiments are possible without changing the basic concept. Those skilled in the art would also appreciate that minor design modifications, such as adding a steam port near the top of the boiler just below the heating position of the piston (FIG. 2E) can be made to allow steam production by the instant machine for use in making milk-based espresso drinks. Finally, those skilled in the art would also appreciate that in addition to espresso, the instant machine can be used to dispense hot water or brew tea or other beverages.

What is claimed is:

1. Apparatus for dispensing hot water, comprising:
an electric motor driving a piston;
a heated vessel or boiler within which said piston moves;
a dispenser for dispensing the heater water.

2. The apparatus of claim 1, further comprising a brew head and a portafilter, wherein said portafilter is adapted to hold beverage material.

3. The apparatus of claim 1, wherein said beverage material is coffee.

4. The apparatus of claim 3, wherein said coffee is in the form of grinds, pods, or capsules.

5. The apparatus of claim 1, wherein said water is heated in the boiler to a temperature of about 185 to 210 deg F.

6. The apparatus of claim 1, wherein said piston and motor are jointly capable of producing pressure of at least about 100 psi.

7. The apparatus of claim 3, wherein the heated water contacts said coffee for about 20 seconds.

8. The apparatus of claim 1, wherein the total power consumption is no more than 120 W at any time during the cycle.

9. The apparatus of claim 1, wherein a reservoir contains additional water requiring less frequent refilling with water.

10. A method for preparing hot liquid, comprising:
providing a heated vessel or boiler;
providing an electric motor driving a piston within said boiler;
heating water in said boiler to a temperature below boiling;
ejecting the resulting heated water from the boiler by means of the said piston.

11. The method of claim 10, further comprising providing a beverage material, and contacting said beverage material with said heated water.

12. The method of claim 11, wherein said beverage material is coffee.

13. The method of claim 12, wherein said coffee is in the form of grinds, pods, or capsules.

14. The method of claim 13, wherein said water is heated to a temperature between about 185 and 210 deg F and contacts said coffee at a pressure of at least about 100 psi.

15. The method of claim 12, wherein the heated water contacts said coffee for about 20 seconds.

16. The method of claim 11, further comprising sensing the temperature of said heated water in said boiler, and commencing said ejection when said sensed temperatures reaches between about 185 and 210 deg F.

17. The method of claim 13, wherein said dispensed hot liquid is espresso.
